(19) United States
(12) Patent Application Publication
(10) Pub. No.: US 2025/0062054 A1
(43) Pub. Date: Feb. 20, 2025

(54) WIRING MEMBER-EQUIPPED ADHEREND AND METHOD OF MANUFACTURING WIRING MEMBER-EQUIPPED ADHEREND

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Daichi FUKUSHIMA, Osaka (JP); Tsutomu TASAKI, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/699,547

(22) PCT Filed: Oct. 14, 2022
(86) PCT No.: PCT/JP2022/038343

§ 371 Date: Apr. 8, 2024

(30) Foreign Application Priority Data
Oct. 28, 2021 (JP) 2021-176549

(51) Int. Cl. H01B 7/40; G02B 6/44; H01B 7/08

(52) U.S. Cl. CPC H01B 7/40; G02B 6/4432; H01B 7/0838

(57) ABSTRACT

A wiring member-equipped adherend includes: an adherend including an attached surface; a first sheet overlapped with the attached surface; a second sheet overlapped with the first sheet; a wire-like transmission member located between the first sheet and the second sheet; and an adhesive member bonding the first sheet, the second sheet, and the adherend. The adhesive member includes a first layer part provided between the first sheet and the attached surface, a second layer part provided on an opposite side of the first sheet from a side of the attached surface, and a connection part connecting the first layer part and the second layer part on a lateral side of the first sheet.

### TECHNICAL FIELD

The present disclosure relates to a wiring member-equipped adherend and a method of manufacturing the wiring member-equipped adherend.

### BACKGROUND ART

Patent Document 1 discloses a technique of keeping a plurality of electrical wires flat. In Patent Document 1, the plurality of electrical wires are sandwiched by two sheets to be kept flat, for example.

### PRIOR ART DOCUMENTS

### Patent Document(s)

Patent Document 1: Japanese Patent Application Laid-Open No. 2019-202730

### SUMMARY

### Problem to be Solved by the Invention

A sheet of a wiring member described in Patent Document 1 is fixed to an adherend in some cases. It is desired that the sheet and the adherend are rigidly fixed. Accordingly, an object is to provide a technique capable of rigidly fixing the sheet and the adherend.

### Means to Solve the Problem

A wiring member-equipped adherend according to the present disclosure is a wiring member-equipped adherend including: an adherend including an attached surface; a first sheet overlapped with the attached surface; a second sheet overlapped with the first sheet; a wire-like transmission member located between the first sheet and the second sheet; and an adhesive member bonding the first sheet, the second sheet, and the adherend, wherein the adhesive member includes a first layer part provided between the first sheet and the attached surface, a second layer part provided on an opposite side of the first sheet from a side of the attached surface, and a connection part connecting the first layer part and the second layer part on a lateral side of the first sheet.

### Effects of the Invention

According to the present disclosure, the sheet and the adherend are rigidly fixed to each other.

### BRIEF DESCRIPTION OF DRAWINGS

FIG. 1 is a plan view illustrating a wiring member-equipped adherend according to an embodiment 1.

FIG. 2 is a cross-sectional view along a II-II line in FIG. 1.

FIG. 3 is an enlarged view of a region Al in FIG. 2.

FIG. 4 is a cross-sectional view illustrating a method of manufacturing the wiring member-equipped adherend according to the embodiment 1.

FIG. 5 is a cross-sectional view illustrating a method of manufacturing the wiring member-equipped adherend according to the embodiment 1.

FIG. 6 is a cross-sectional view illustrating a wiring member-equipped adherend according to another example.

FIG. 7 is a cross-sectional view illustrating a wiring member-equipped adherend according to a first modification example.

FIG. 8 is a cross-sectional view illustrating a wiring member-equipped adherend according to a second modification example.

FIG. 9 is a cross-sectional view illustrating a wiring member-equipped adherend according to a third modification example.

### DESCRIPTION OF EMBODIMENT(S)

### Description of Embodiment of Present Disclosure

Embodiments of the present disclosure are listed and described firstly.

A wiring member-equipped adherend according to the present disclosure is as

follows.
(1) A wiring member-equipped adherend includes: an adherend including an attached surface; a first sheet overlapped with the attached surface; a second sheet overlapped with the first sheet; a wire-like transmission member located between the first sheet and the second sheet; and an adhesive member bonding the first sheet, the second sheet, and the adherend, wherein the adhesive member includes a first layer part provided between the first sheet and the attached surface, a second layer part provided on an opposite side of the first sheet from a side of the attached surface, and a connection part connecting the first layer part and the second layer part on a lateral side of the first sheet. A lateral edge of the first sheet is surrounded by the first layer part, the second layer part, and the connection part, thus the first sheet is hardly detached from the adherend, and the first sheet and the adherend are rigidly bonded to each other.
(2) In the wiring member-equipped adherend according to (1), the second layer part may be located between the first sheet and the second sheet. Accordingly, first sheet and the second sheet are bonded and fixed to each other via the second layer part.
(3) In the wiring member-equipped adherend according to (2), the adhesive member may include an exposed part exposed to a lateral side of a side edge of the second sheet along a width direction of the second sheet. Accordingly, even the side edge of the second sheet is easily bonded to the adhesive member, and the side edge of the second sheet is hardly detached from the adhesive member.
(4) In the wiring member-equipped adherend according to (3), a protruding part protruding farther from the attached surface than the second layer part may be provided to the exposed part along a thickness direction of the adhesive member. Accordingly, the protruding part serves as an indication that the adhesive member is appropriately bonded.
(5) In the wiring member-equipped adherend according to any one of (1) to (4),

the second sheet may include an extension part extending to a lateral side of the first sheet to cover the connection part. Accordingly, the extension part of the second sheet is bonded and fixed to the attached surface via the connection part without intervention of the first sheet.
(6) In the wiring member-equipped adherend according to any one of (1) to (5), it is applicable that the adhesive member includes a first end portion and a second end portion along an extension direction of the wire-like transmission member, and the connection part continuously extends from the first end portion to the second end portion. Accordingly, the first layer part and the second layer part can be connected via the connection part over a whole length of the adhesive member along the extension direction of the wire-like transmission member.
(7) In the wiring member-equipped adherend according to any one of (1) to (6), it is applicable that the first sheet includes a first non-woven cloth having contact with the first layer part, and the adhesive member includes a first penetrating layer part continuously formed with the first layer part and penetrating the first non-woven cloth. Accordingly, anchor effect is generated in bonding the adhesive member and the first sheet.
(8) In the wiring member-equipped adherend according to any one of (1) to (7), it is applicable that the second sheet includes a second non-woven cloth having contact with the second layer part, and the adhesive member includes a second penetrating layer part continuously formed with the second layer part and penetrating the second non-woven cloth. Accordingly, anchor effect is generated in bonding the adhesive member and the second sheet.
(9) In the wiring member-equipped adherend according to any one of (1) to (8), the wire-like transmission member may be fixed to any one of the first sheet and the second sheet. Accordingly, when the first sheet and the second sheet sandwich the wire-like transmission member, the wire-like transmission member may hardly come out from between the first sheet and the second sheet. Accordingly, a fixing operation is easily performed.
(10) A method of manufacturing a wiring member-equipped adherend according to the present disclosure is a method of manufacturing a wiring member-equipped adherend including: a step of overlapping an adhesive member sheet, a first sheet, a wire-like transmission member, and a second sheet in this order on an attached surface of an adherend and bending a part of the adhesive member sheet protruding to a lateral side of the first sheet so that the part is overlapped to have contact with the second sheet; and a step of heating and softening the adhesive member sheet which has been bended to bond the adherend, the first sheet, and the second sheet via the adhesive member sheet. Accordingly, the adherend, the first sheet, and the second sheet can be collectively bonded and fixed by the bended adhesive member sheet.

### Detailed Description of Embodiment of Present Disclosure

Specific examples of a wiring member-equipped adherend and a method of manufacturing a wiring member-equipped adherend according to the present disclosure are described hereinafter with reference to the drawings. The present disclosure is not limited to these examples, but is indicated by claims, and it is intended that meanings equivalent to claims and all modifications within a scope of claims are included.

### Embodiment 1

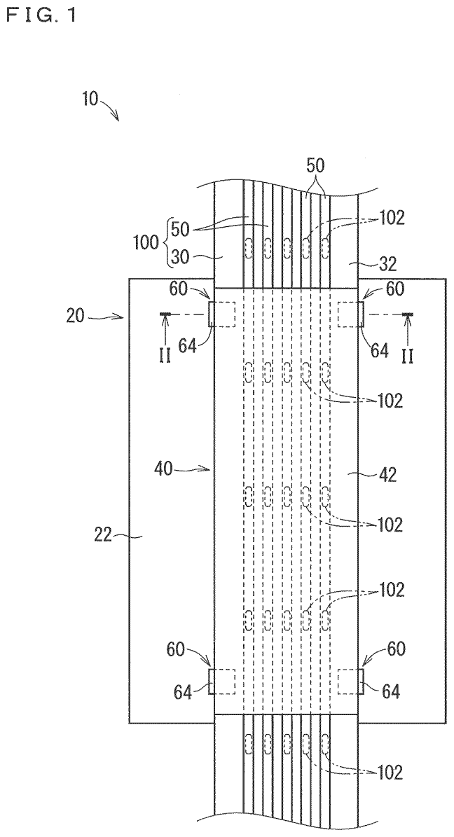

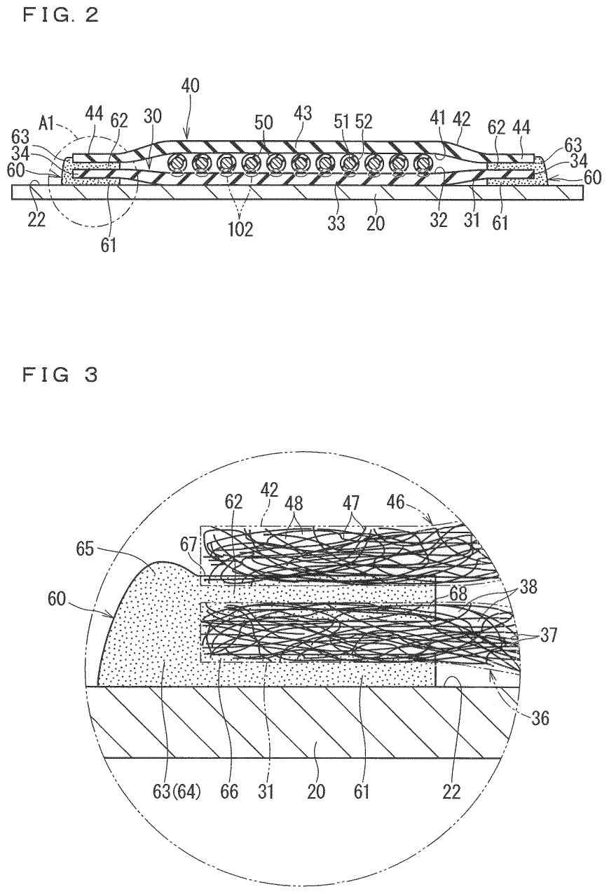

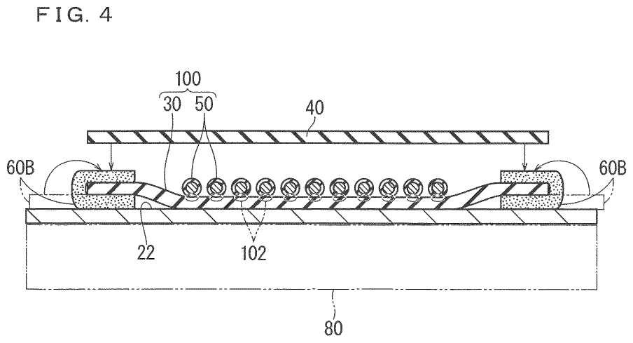

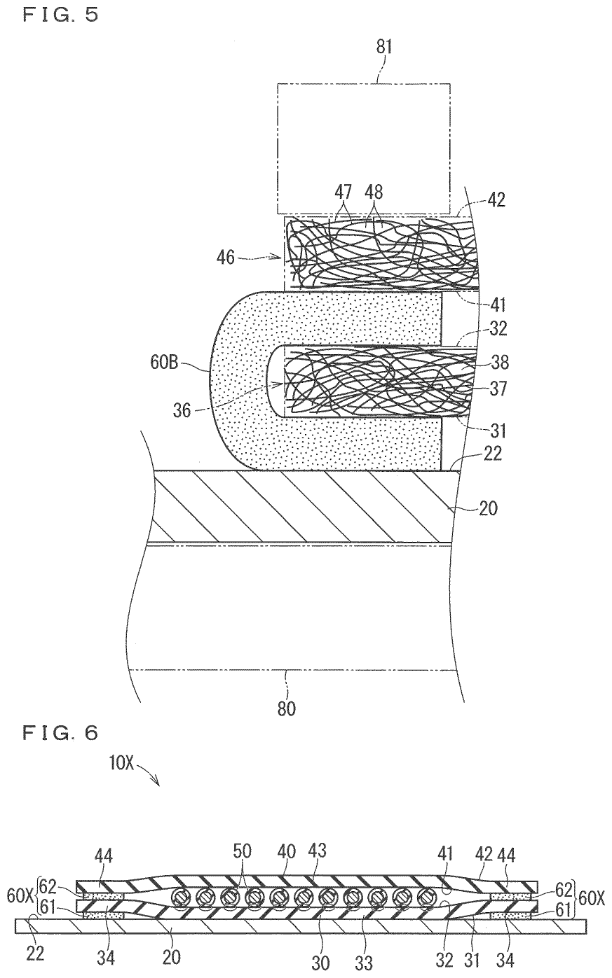

A wiring member-equipped adherend and a manufacturing method thereof according to an embodiment 1 are described hereinafter. FIG. 1 is a plan view illustrating the wiring member-equipped adherend according to the embodiment 1. FIG. 2 is a cross-sectional view along a II-II line in FIG. 1. FIG. 3 is an enlarged view of the region A1 in FIG. 2. FIG. 4 and FIG. 5 are cross-sectional views each illustrating a method of manufacturing the wiring member-equipped adherend according to the embodiment 1. FIG. 4 and FIG. 5 are schematic cross-sectional views in a position similar to that in FIG. 3.

The wiring member-equipped adherend 10 includes an adherend 20, a first sheet 30, a second sheet 40, a wire-like transmission member 50, and an adhesive member 60.

The adherend 20 is a member provided in a position where the wire-like transmission member 50 is disposed in a vehicle. In the example illustrated in FIG. 1, an intermediate portion of the wire-like transmission members 50 is disposed on the adherend 20. A first end portion of the wire-like transmission member 50 extends to an outer side from a first end portion of the adherend 20. A second end portion of the wire-like transmission member 50 extends to an outer side from a second end portion of the adherend 20. One of or both the first end portion and the second portion of the wire-like transmission member 50 may be disposed on the adherend 20.

The adherend 20 is a component provided to a vehicle. For example, the adherend 20 is a member provided to a vehicle later. The adherend 20 may be incorporated into the vehicle together with the wire-like transmission member 50. The adherend 20 and the wire-like transmission member 50 may be transported to a vehicle assembly plant in a state of the wiring member-equipped adherend 10. The adherend 20 may be a rigid member, for example. Each of the flexible first sheet 30, second sheet 40, and wire-like transmission member 50 may be fixed to the adherend 20, thereby being kept in a shape corresponding to the adherend 20.

The adherend 20 may be a bracket, for example. The adherend 20 may have the other function in addition to the function of fixing the wire-like transmission member 50. Such a function may be a function of fixing an apparatus, for example. The adherend 20 may be provided with a fixing part fixed to a vehicle. When the adherend 20 and the vehicle are fixed by a screw, the fixing part provided to the adherend 20 is preferably a part used for screwing, and may be a through hole, a screw hole, a nut, or a stud bolt, for example.

The adherend 20 may be a member previously assembled to a vehicle before the wire-like transmission member 50 is assembled to the vehicle. The adherend 20 and the wire-like transmission member 50 may be transported to a vehicle assembly plant separately from each other. For example, the adherend 20 may be a body panel or a body frame.

The adherend 20 includes an attached surface 22. The first sheet 30 is bonded to the attached surface 22 via the adhesive member 60. Herein, the attached surface 22 is made of metal. The adherend 20 is a member including a metal member such as a single body of a metal member or a composite member of a metal member and a resin member, for example. A surface of this metal member serves as the attached surface 22. However, the attached surface 22 may be made of resin. In this case, the adherend 20 is a member including a resin member such as a single body of a resin member or a composite member of a metal member and a resin member, for example, and a surface of the resin member serves as the attached surface 22.

The first sheet 30 is overlapped with the attached surface 22. The first sheet 30 includes a first surface 31 and a second surface 32. The first surface 31 is a surface directed to the attached surface 22. The second surface 32 is a surface directed to the second sheet 40.

A part of the first sheet 30 serves as a cover part 33, and the other part thereof serves as a sheet fixing part 34. The cover part 33 is a part covering the wire-like transmission member 50. The sheet fixing part 34 is a part fixed to the second sheet 40. An intermediate portion of the first sheet 30 along a parallel direction of the wire-like transmission member 50 is the cover part 33 and both end portions thereof is the sheet fixing part 34.

The second sheet 40 is overlapped with the first sheet 30. The second sheet 40 includes a third surface 41 and a fourth surface 42. The third surface 41 is a surface directed to the first sheet 30. The fourth surface 42 is a surface directed to a side opposite to the third surface 41.

A part of the second sheet 40 serves as a cover part 43, and the other part thereof serves as a sheet fixing part 44. The cover part 43 is a part covering the wire-like transmission member 50 from a side opposite to the cover part 33. The wire-like transmission member 50 is disposed between the cover parts 33 and 43. The sheet fixing part 44 is a part fixed to the first sheet 30. The sheet fixing parts 34 and 44 are fixed by the adhesive member 60 while being in contact with each other. An intermediate portion of the second sheet 40 along the parallel direction of the wire-like transmission member 50 is the cover part 43 and both end portions thereof is the sheet fixing part 44.

The first sheet 30 is longer than the second sheet 40 along an extension direction of the wire-like transmission member 50. In the example illustrated in FIG. 1, the first sheet 30 is longer than the adherend 20. A first end portion of the first sheet 30 extends to an outer side from the first end portion of the adherend 20 together with the wire-like transmission member 50. A second end portion of the first sheet 30 extends to an outer side from the second end portion of the adherend 20 together with the wire-like transmission member 50. One of or both the first end portion and the second portion of the first sheet 30 may be disposed on the adherend 20.

The second sheet 40 is shorter than the first sheet 30 along the extension direction of the wire-like transmission member 50. In the example illustrated in FIG. 1, the second sheet 40 substantially has the same length as the adherend 20. A dimension along the extension direction of the wire-like transmission member 50 is larger than that along the parallel direction of the wire-like transmission member 50 in the second sheet 40. Both a first end portion and a second portion of the second sheet 40 are disposed on the adherend 20. The first end portion of the second sheet 40 is disposed on the first end portion of the adherend 20, and the second end portion of the second sheet 40 is disposed on the second end portion of the adherend 20. One of or both the first end portion and the second portion of the second sheet 40 may extend to an outer side from the end portion of the adherend 20.

The second sheet 40 may be formed to have a small length along the extension direction of the wire-like transmission member 50 to be provided in a plurality of positions at intervals on the adherend 20. A dimension along the extension direction of the wire-like transmission member 50 may be smaller than that along the parallel direction of the wire-like transmission member 50 in the second sheet 40.

The first sheet 30 includes a non-woven cloth layer 36. A void 38 is formed between a plurality of fibers 37 in the non-woven cloth layer 36. The void 38 reaches the second surface 32 from the first surface 31. In the present example, the first sheet 30 has a single layer structure. The first sheet 30 includes only the non-woven cloth layer 36. The first sheet 30 may also have a multilayer structure.

The second sheet 40 includes a non-woven cloth layer 46. A void 48 of the second sheet 40 is formed between a plurality of fibers 47 in the non-woven cloth layer 46. The void 48 reaches the fourth surface 42 from the third surface 41. In the present example, the second sheet 40 has a single layer structure. The second sheet 40 includes only the non-woven cloth layer 46. The second sheet 40 may also have a multilayer structure.

The fibers 37 and 47 in the non-woven cloth layers 36 and 46 may be synthesized fibers or natural fibers. The synthesized fiber may be made of resin. A type of the resin is not particularly limited, but polyethylene terephthalate (PET), polyvinyl chloride (PVC), polyethylene (PE), or polypropylene (PP), can be adopted, for example. A non-woven cloth of the non-woven cloth layer 36 and a non-woven cloth of the non-woven cloth layer 46 may be the same type or different types of cloth. A material, a thickness, or a weight per area, for example, may be different as two different types of non-woven cloth.

The wire-like transmission member 50 is a wire-like member transmitting electricity or light, for example. One or a plurality of wire-like transmission members 50 are provided. The wire-like transmission member 50 is assumed to be a member connecting components in a vehicle. A connector, for example, is provided to an end portion of the wire-like transmission member 50. This connector is connected to a connector provided to the other side component, thus the wire-like transmission member 50 is connected to the other side component. The connector may be fixed to the first sheet 30. The connector may be provided to an outer side of the first sheet 30.

The wire-like transmission member 50 includes a transmission wire body 51 and a covering layer 52. The transmission wire body 51 is a transmission route transmitting electricity or light. For example, when the wire-like transmission member 50 is an electrical wire, the transmission wire body 51 is a conductor core wire. The conductor core wire is made up of one or a plurality of strands. The strand is formed of copper, copper alloy, aluminum, or aluminum alloy as a material, for example. For example, when the wire-like transmission member 50 is an optical fiber, the transmission wire body 51 is a core and a clad. The covering layer 52 is a layer covering the transmission wire body 51. A resin material constituting the covering layer 52 is not particularly limited, but can be appropriately set. For example, the wire-like transmission member 50 may be a general wire having a core wire and a covering layer around the core wire, or may also be a shield wire, a twisted wire, an enamel wire, a nichrome wire, or an optical fiber.

The wire-like transmission member 50 transmitting the electricity may be various kinds of signal lines or various kinds of power lines. Some of the wire-like transmission members 50 transmitting the electricity may be used as an antenna or coil, for example, transmitting or receiving a signal or electrical power to or from a space.

The wire-like transmission member 50 may be a single core wire. The single core wire is a single wire-like object. The single core wire is the wire-like transmission member 50 with one transmission path. The wire-like transmission member 50 may be a multicore wire. The multicore wire is a compound body of a plurality of wire-like objects. The multicore wire is the wire-like transmission member 50 with a plurality of transmission paths. The multicore wire may be a cable made up of collected twisted wires or a plurality of wire-like objects covered by a sheath, for example.

The wire-like transmission member 50 is located between the first sheet 30 and the second sheet 40. The wire-like transmission member 50 is fixed to any one of the first sheet 30 and the second sheet 40. In the present example, the wire-like transmission member 50 is fixed to the first sheet 30. In the description hereinafter, the first sheet 30 and the wire-like transmission member 50 integrated with each other are referred to as a wiring body 100. The wiring body 100 is used as a wiring member electrically connecting various types of component in a vehicle, for example (or connecting them so that they can perform optical communication).

The first sheet 30 and the wire-like transmission member 50 are partially fixed to each other along the extension direction of the wire-like transmission member 50. The fixing part thereof is referred to as a spot fixing part 102. The plurality of spot fixing parts 102 are provided at intervals along the extension direction of the wire-like transmission member 50. The interval between the spot fixing parts 102 is not particularly limited, but can be appropriately set. However, the fixing part between the first sheet 30 and the wire-like transmission member 50 needs not be the spot fixing part 102. The fixing part between the first sheet 30 and the wire-like transmission member 50 may be continuously provided to have a large length along the extension direction of the wire-like transmission member 50.

Any fixing state may be applied as a fixing state in the spot fixing part 102 between the first sheet 30 and the wire-like transmission member 50. Applicable as the fixing state are a contact area fixation and a non-contact area fixation, or both fixations may be used together. Herein, the contact area fixation indicates that a portion where the first sheet 30 and the wire-like transmission member 50 have contact with each other is stuck and fixed. The non-contact area fixation is a fixing state which is not the contact area fixation, and indicates that a sewing thread, a cover, or an adhesive tape presses the wire-like transmission member 50 toward the first sheet 30 or sandwiches the first sheet 30 and the wire-like transmission member 50 to keep them in a fixing state. In the description hereinafter, the first sheet 30 and the wire-like transmission member 50 are in the state of the contact area fixation.

Applicable as the configuration of the contact area fixation are a contact area indirect fixation and a contact area direct fixation, or both fixations may also be used together in different regions. Herein, the contact area indirect fixation indicates that the first sheet 30 and the wire-like transmission member 50 are indirectly stuck and fixed via an adhesive member such as an adhesive agent, a gluing agent, and a double-sided adhesive tape provided therebetween. The contact area direct fixation indicates that the first sheet 30 and the wire-like transmission member 50 are directly stuck and fixed without an intervention of the adhesive member, for example, which is separately provided. Considered in the contact area direct fixation is that resin included in at least one of the first sheet 30 and/or the wire-like transmission member 50 is melted, thus the first sheet 30 and the wire-like transmission member 50 are stuck and fixed, for example.

In forming the state of such a contact area direct fixation, the resin is considered to be melted by heat or a solvent, for example. That is to say, the state of the contact area direct fixation may be the state of the contact area direct fixation by the heat or the state of the contact area direct fixation by the solvent. The contact area direct fixation by the heat is preferable.

At this time, a means of forming the state of the contact area direct fixation is not particularly limited, but a known means such as welding, fusion, and melting joint can be used. Herein, in the spot fixing part 102 between the first sheet 30 and the wire-like transmission member 50, the first sheet 30 and the wire-like transmission member 50 are fused to each other. In the present example, the non-woven cloth layer 36 of the first sheet 30 and an outermost layer of the wire-like transmission member 50 are fused to each other. The outermost layer of the wire-like transmission member 50 is the covering layer 52.

A route of the wire-like transmission member 50 is set in accordance with a position of a component to which the wire-like transmission member 50 is connected, for example. The wire-like transmission members 50 are fixed to the first sheet 30, thus the wire-like transmission members 50 are kept in a form following a wiring route corresponding to a position of a component as a connection destination of each wire-like transmission member 50. Herein, the wire-like transmission members 50 extend straight on the first sheet 30. The first sheet 30 is formed into a shape in accordance with a route of the wire-like transmission member 50 (straight shape, herein). However, the route of the wire-like transmission members 50 may be made up of a combination of a straight route and a bending route. The first sheet 30 may also be made up of a combination of a straight route and a bending route. The plurality of wire-like transmission members 50 may be fixed to the first sheet 30 in a state where a branch wire is branched from a main wire. The first sheet 30 may also be formed into a shape in which a part to which the branch wire is fixed is branched from a part to which the main wire is fixed.

The first sheet 30 and the second sheet 40 may be flexible members. For example, the first sheet 30 and the second sheet 40 are non-woven clothes having flexibility, and are flexible members. For example, the first sheet 30 may have flexibility so as to be able to follow bending of the wire-like transmission member 50. It is also applicable that the first sheet 30 and the wire-like transmission member 50 can be bended in a thickness direction (bending so that a fold line follows a main surface of the first sheet 30).

Herein, the first sheet 30 and the second sheet 40 have the same width dimension. The first sheet 30 and the second sheet 40 are overlapped with each other so that both side edges are aligned with each other. The first sheet 30 and the second sheet 40 may have different width dimensions. The side edge of the first sheet 30 may protrude to an outer side of the side edge of the second sheet 40 in at least one side edge. The side edge of the second sheet 40 may protrude to an outer side of the side edge of the first sheet 30 in at least one side edge.

The adhesive member 60 bonds the adherend 20, the first sheet 30, and the second sheet 40. The adhesive member 60 includes a first layer part 61, a second layer part 62, and a connection part 63. The first layer part 61 is provided between the first surface 31 and the attached surface 22. The second layer part 62 is provided on an opposite side of the first sheet 30 from a side of the attached surface 22. The second layer part 62 is provided farther away from the attached surface 22 in relation to the first sheet 30. Herein, the second layer part 62 is located between the first sheet 30 and the second sheet 40. The connection part 63 connects the first layer part 61 and the second layer part 62 on a lateral side of the first sheet 30.

The first layer part 61 is bonded to the attached surface 22 and the first surface 31. The first surface 31 is bonded to the attached surface 22 via the first layer part 61. The first surface 31 does not have contact with the attached surface 22 in the sheet fixing part 34 of the first sheet 30. The first surface 31 is located away from the attached surface 22 by a thickness of the first layer part 61 in the sheet fixing part 34 of the first sheet 30. The adhesive member 60 is not provided to a portion of the cover part 33 herein. The first surface 31 has contact with the attached surface 22 in the cover part 33 of the first sheet 30. The adhesive member 60 may also be provided to a portion of the cover part 33.

The second layer part 62 is bonded to at least the second sheet 40. Herein, the second layer part 62 is bonded to the first sheet 30 and the second sheet 40. The second layer part 62 is bonded to the second surface 32 and the third surface 41. Parts of the second surface 32 and the third surface 41 on a lateral side of the wire-like transmission member 50 are bonded to each other via the second layer part 62. The sheet fixing part 34 of the second surface 32 is bonded to the sheet fixing part 44 of the third surface 41 via the second layer part 62.

The connection part 63 is overlapped with the attached surface 22 on the lateral side of the first sheet 30, that is to say, on an outer side of the first sheet 30 along a width direction of the first sheet 30. The connection part 63 is bonded to the attached surface 22. The connection part 63 is not overlapped with the first sheet 30 in a lamination direction of the attached surface 22 and the first sheet 30. The connection part 63 covers a lateral end surface of the first sheet 30. The connection part 63 may be or may not be bonded to the lateral end surface of the first sheet 30.

In the example illustrated in FIG. 1, the adhesive member 60 is partially provided along the extension direction of the wire-like transmission member 50. The adhesive member 60 is provided in a plurality of positions at intervals along the extension direction of the wire-like transmission member 50. The adhesive member 60 is provided to the first end portion and the second end portion of the adherend 20. The adhesive member 60 is not provided between the first end portion and the second end portion of the adherend 20. The adhesive member 60 may be provided between the first end portion and the second end portion of the adherend 20. The adhesive member 60 may be continuously provided between the first end portion and the second end portion of the adherend 20.

The adhesive member 60 includes a first end portion and a second end portion along the extension direction of the wire-like transmission member 50. The connection part 63 continuously extends from the first end portion to the second end portion of the adhesive member 60. Herein, the connection part 63 continuously extends from the first end portion to the second end portion of each adhesive member 60 provided to each of four corners of the second sheet 40.

Herein, the sheet fixing part 34 of the first sheet 30 is sandwiched between the first layer part 61 and the second layer part 62 in a lamination direction with respect to the attached surface 22, and is covered by the connection part 63 from an outer side in a direction intersecting with the lamination direction. The first layer part 61, the second layer part 62, and the connection part 63 have a U-like cross-sectional shape, and surround the sheet fixing part 34 of the first sheet 30.

The adhesive member 60 further includes an exposed part 64. The exposed part 64 is exposed to a lateral side of the side edge of the second sheet 40 along a width direction of the second sheet 40. Herein, the exposed part 64 is provided to the connection part 63. Herein, the side edge of the first sheet 30 and the side edge of the second sheet 40 are aligned with each other, thus the whole connection part 63 serves as the exposed part 64. For example, when the side edge of the first sheet 30 protrudes to an outer side of the side edge of the second sheet 40, the exposed part 64 includes the whole connection part 63 and a part overlapped with a protruding part of the first sheet 30. For example, when the side edge of the second sheet 40 protrudes to an outer side of the side edge of the first sheet 30, a part of the connection part 63 protruding to the outer side of the side edge of the second sheet 40 serves as the exposed part 64. When the side edge of the second sheet 40 protrudes to the outer side of the first sheet 30, there may be no exposed part 64 in some cases.

The protruding part 65 is provided to the exposed part 64. The protruding part 65

protrudes farther from the attached surface 22 than the second layer part 62 along a thickness direction of the adhesive member 60. The protruding part 65 may have a curved convex surface as illustrated in FIG. 3. The curved convex surface may have a circular shape in cross-section. The curved convex surface may be continuously formed to reach the attached surface 22. A contact angle between the curved convex surface and the attached surface 22 may be an angle corresponding to wettability of the attached surface 22 and the adhesive member 60. The protruding part 65 is generated by applying pressure to a part of the adhesive member 60 to be bonded when the adhesive member 60 is heated and softened.

Herein, the adhesive member 60 includes a first penetrating layer part 66, a second penetrating layer part 67, and a third penetrating layer part 68.

The first penetrating layer part 66 is continuously formed with the first layer part 61. The first penetrating layer part 66 is a part penetrating the non-woven cloth layer 36 in the first sheet 30. The first penetrating layer part 66 penetrates the non-woven cloth layer 36 from the first layer part 61 via the void 38. An area around some fibers 37 is covered by the adhesive member 60 of the first penetrating layer part 66 on at least a side of the first surface 31 of the first sheet 30.

The second penetrating layer part 67 is continuously formed with the second layer part 62. The second penetrating layer part 67 is a part penetrating the non-woven cloth layer 46 in the second sheet 40. The second penetrating layer part 67 penetrates the non-woven cloth layer 46 from the second layer part 62 via the void 48. An area around some fibers 47 is covered by the adhesive member 60 of the second penetrating layer part 67 on at least a side of the third surface 41 of the second sheet 40.

The third penetrating layer part 68 is continuously formed with the second layer part 62. The third penetrating layer part 68 is a part penetrating the non-woven cloth layer 36 in the first sheet 30. The third penetrating layer part 68 penetrates the non-woven cloth layer 36 from the second layer part 62 via the void 38. An area around some fibers 37 is covered by the adhesive member 60 of the third penetrating layer part 68 on at least a side of the second surface 32 of the first sheet 30.

A degree of penetration of the first penetrating layer part 66, the second penetrating layer part 67, and the third penetrating layer part 68 is not particularly limited, but can be appropriately set. For example, as illustrated in FIG. 3, there may be a layer which the adhesive member 60 does not penetrate between the first penetrating layer part 66 and the third penetrating layer part 68 in the first sheet 30. For example, the first penetrating layer part 66 and the third penetrating layer part 68 may be continuously formed in a lamination direction. The adhesive member 60 may wholly penetrate along a thickness direction in the sheet fixing part 34. For example, the second penetrating layer part 67 may not reach the fourth surface 42 as illustrated in FIG. 3. For example, the second penetrating layer part 67 may reach the fourth surface 42.

A type of the adhesive member 60 is not particularly limited, however, any type is applicable as long as the adhesive member 60 is heated to be able to have adhesion properties. It is also applicable that the adhesive member 60 is heated and softened to have flowability. The adhesive member 60 may be a hot-melt adhesive agent, for example.

A thickness dimension of the first layer part 61 and a thickness dimension of the second layer part 62 are not particularly limited, but can be appropriately set. For example, the thickness dimension of the first layer part 61 and the thickness dimension of the second layer part 62 may be the same as that of the sheet fixing part 34 of the first sheet 30, or may also be larger or smaller than that thereof. For example, the thickness dimension of the first layer part 61 and the thickness dimension of the second layer part 62 may be equal to or larger 0.1 mm and equal to or smaller than 2 mm.

The width dimension of the first layer part 61 and the width dimension of the second layer part 62 are not particularly limited, but can be appropriately set. For example, the width dimension of the first layer part 61 and the width dimension of the second layer part 62 may be larger than that of the first layer part 61 and that of the second layer part 62. For example, the width dimension of the first layer part 61 and the width dimension of the second layer part 62 may be equal to or larger 5 mm and equal to or smaller than 20 mm.

The width dimension of the connection part 63 is not particularly limited, but can be appropriately set. For example, the width dimension of the connection part 63 may be larger than the thickness dimension of the first layer part 61 and the thickness dimension of the second layer part 62. For example, the width dimension of the connection part 63 may be smaller than that of the first layer part 61 and that of the second layer part 62. For example, the width dimension of the connection part 63 may be equal to or larger 0.5 mm and equal to or smaller than 5 mm.

### <Manufacturing Method>

A method of manufacturing the wiring member-equipped adherend 10 is described next.

The method of manufacturing the wiring member-equipped adherend 10 includes an overlapping process and a bonding process.

In the overlapping process, an adhesive member sheet 60B, the first sheet 30, the wire-like transmission member 50, and the second sheet 40 are overlapped with each other in this order on the attached surface 22 of the adherend 20. In the example illustrated in FIG. 4, the first sheet 30 and the wire-like transmission member 50 are integrally provided to be the wiring body 100. A part of the adhesive member sheet 60B protruding to a lateral side of the first sheet 30 is bended and overlapped to have contact with the second sheet 40 in the overlapping process. Herein, the part of the adhesive member sheet 60B which has been bended is overlapped to be located between the first sheet 30 and the second sheet 40 as illustrated in FIG. 4.

The adhesive member sheet 60B which has been bended is heated and softened to be bonded the adherend 20, the first sheet 30, and the second sheet 40 via the adhesive member sheet 60B in the bonding process. A method of heating the adhesive member sheet 60B is not particularly limited, but can be appropriately set. When the adhesive member sheet 60B is heated, the adhesive member is softened over time and has adhesion properties. The adhesive member having the adhesion properties is bonded to the attached surface 22 and the sheet fixing parts 34 and 44, thus the adherend 20, the first sheet 30, and the second sheet 40 are bonded to each other via the adhesive member sheet 60B.

In the bonding process, the adhesive member sheet 60B may be heated while the adhesive part is pressed by press members 80 and 81 as illustrated in FIG. 5. That is to say, the adhesive part may be heated and pressed. When the adhesive part is heated and pressed, the sheet fixing parts 34 and 44 may be compressed and deformed to have a smaller thickness than the cover parts 33 and 43 in some cases. As illustrated in FIG. 5, only a part of the adhesive part provided with the second sheet 40 may be heated and pressed in the bonding process. In this case, the adhesive member may be leaked to an outer side of the second sheet 40 to constitute the protruding part 65 described above.

In the bonding process, the adhesive member which has been heated and softened may penetrate the non-woven cloth layers 36 and 46. When the adhesive part is pressed, the adhesive member which has been heated and softened easily penetrates the non-woven cloth layers 36 and 46.

The wiring member-equipped adherend 10 described above is completed while the adhesive member penetrating the inner part of the second sheet 40 does not reach the fourth surface 42. For example, the adhesive member penetrating the inner part of the second sheet 40 can be prevented from reaching the fourth surface 42 by adjusting a heating time or pressure of the press member.

### <Effect etc.>

According to the wiring member-equipped adherend 10 having the above configuration, the side edge of the first sheet 30 is surrounded by the first layer part 61, the second layer part 62, and the connection part 63, thus the side edge of the first sheet 30 is hardly detached from the adherend 20, and the first sheet 30 and the adherend 20 are rigidly bonded to each other.

This configuration is described in detail with reference to FIG. 6. FIG. 6 is a cross-sectional view illustrating a wiring member-equipped adherend 10X according to another example.

The wiring member-equipped adherend 10X is similar to the wiring member-equipped adherend 10 except for an adhesive member 60X, thus the same reference numeral is assigned, and the description thereof is omitted. The adhesive member 60X is different from the adhesive member 60 in that the adhesive member 60X does not include the connection part 63. Thus, the first layer part 61 and the second layer part 62 are not continuously formed but are located independently from each other in the adhesive member 60X. In this case, there is a possibility that the side edge of the first sheet 30 located on a lateral side of a part thereof bonded to the adhesive member 60X protrudes to an outer side of the adhesive member 60X, and is caught by a surrounding member.

In contrast. the side edge of the first sheet 30 is surrounded by the first layer part 61, the second layer part 62, and the connection part 63 in the wiring member-equipped adherend 10, thus is hardly caught by the surrounding member.

The second layer part 62 is located between the first sheet 30 and the second sheet 40. Accordingly, first sheet 30 and the second sheet 40 are bonded and fixed to each other via the second layer part 62 located therebetween. When the adhesive part is sandwiched between the press members 80 and 81, the press member 81 can have contact with the second sheet 40, thus contact of the press member 81 with the adhesive member sheet 60B is suppressed.

The adhesive member 60 includes the exposed part 64 exposed to the lateral side of the side edge of the second sheet 40 along the width direction of the second sheet 40. Accordingly, even the side edge of the second sheet 40 is easily bonded to the adhesive member 60, and the side edge of the second sheet 40 is hardly detached from the adhesive member 60.

Provided in the exposed part 64 is the protruding part 65 protruding farther from the attached surface 22 than the second layer part 62 along the thickness direction of the adhesive member 60. The protruding part 65 is located, the protruding part 65 serves as an indication that the adhesive member 60 is appropriately bonded. For example, in the case where the adhesive part is heated and pressed as described above, when energy applied to the adhesive part is small, the protruding part 65 is hardly generated. Accordingly, when the protruding part 65 is generated, it can be deemed that sufficiently large energy has been applied to the adhesive part.

The adhesive member 60 includes the first end portion and the second end portion along the extension direction of the wire-like transmission member 50, and the connection part 63 continuously extends from the first end portion to the second end portion. Accordingly, the first layer part 61 and the second layer part 62 can be connected via the connection part 63 over a whole length of the adhesive member 60 along the extension direction of the wire-like transmission member 50.

The first sheet 30 includes the non-woven cloth layer 36 as the first non-woven cloth having contact with the first layer part 61, and the adhesive member 60 includes the first penetrating layer part 66 continuously formed with the first layer part 61 and penetrating the non-woven cloth layer 36. Accordingly, anchor effect is generated in bonding the adhesive member 60 and the first sheet 30.

The second sheet 40 includes the non-woven cloth layer 46 as the second non-woven cloth having contact with the second layer part 62, and the adhesive member 60 includes the second penetrating layer part 67 continuously formed with the second layer part 62 and penetrating the non-woven cloth layer 46. Accordingly, anchor effect is generated in bonding the adhesive member 60 and the second sheet 40.

The wire-like transmission member 50 is fixed to any one of the first sheet 30 and the second sheet 40. Accordingly, when the first sheet 30 and the second sheet 40 sandwich the wire-like transmission member 50, the wire-like transmission member 50 hardly comes out from between the first sheet 30 and the second sheet 40. Accordingly, a fixing operation is easily performed.

According to the method of manufacturing the wiring member-equipped adherend 10, the adherend 20, the first sheet 30, and the second sheet 40 can be collectively bonded and fixed by the bended adhesive member sheet 60B.

### Appendix

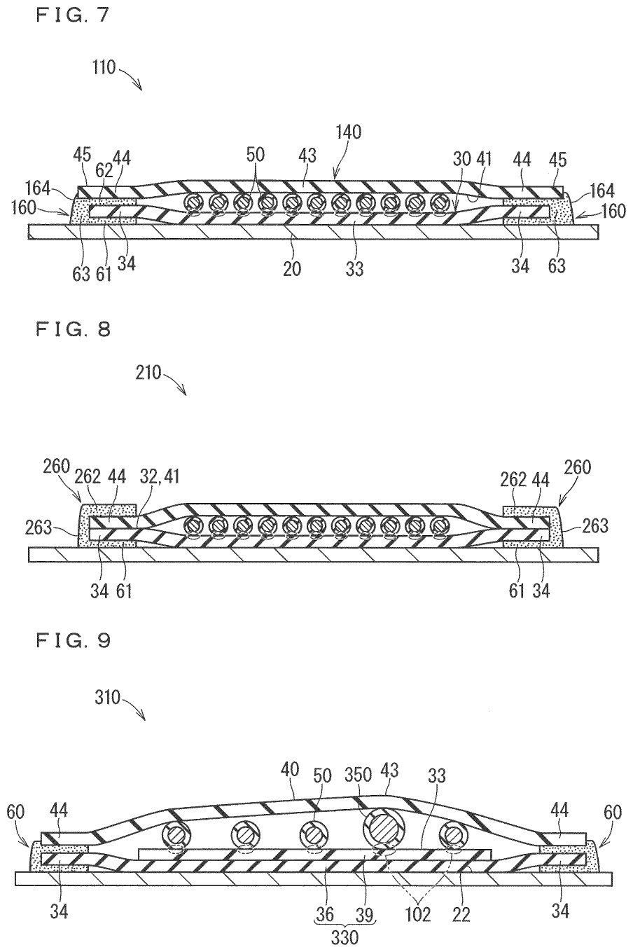

FIG. 7 is a cross-sectional view illustrating a wiring member-equipped adherend 110 according to a first modification example.

A second sheet 140 of the wiring member-equipped adherend 110 includes an extension part 45 extending to the lateral side of the first sheet 30 to cover the connection part 63. Accordingly, the extension part 45 of the second sheet 140 is bonded and fixed to the attached surface 22 via the connection part 63 without intervention of the first sheet 30.

A major part of the connection part 63 is covered by the extension part 45 in the wiring member-equipped adherend 10. Accordingly, an exposed part 164 of an adhesive member 160 in the wiring member-equipped adherend 110 is smaller than the exposed part 64 of the adhesive member 60 in the wiring member-equipped adherend 10. There may be no exposed part 164 in the wiring member-equipped adherend 110 in some cases.

The protruding part 65 is not provided to the exposed part 164 of the wiring member-equipped adherend 110. The protruding part 65 may also be provided to the exposed part 164 of the wiring member-equipped adherend 110.

FIG. 8 is a cross-sectional view illustrating a wiring member-equipped adherend 210 according to a second modification example.

A second layer part 262 of an adhesive member 260 is located on an opposite side of the second sheet 40 from the first sheet 30 in the wiring member-equipped adherend 210. The second layer part 262 is bonded to the fourth surface 42 of the second sheet 40. The first layer part 61 and the second layer part 262 sandwich the sheet fixing parts 34 and 44. A connection part 263 covers a lateral end surface of the first sheet 30 and a lateral end surface of the second sheet 40 from an outer side.

The second surface 32 and the third surface 41 have contact with each other without intervention of the adhesive member 260. The fibers 37 of the second surface 32 and the fibers 47 of the third surface 41 have contact with each other. The second surface 32 and the third surface 41 may not be bonded to each other. The second surface 32 and the third surface 41 may be bonded to each other. The first penetrating layer part 66 may reach the second surface 32 to penetrate the second sheet 40 from the third surface 41. The second penetrating layer part 67 may reach the third surface 41 to penetrate the first sheet 30 from the second surface 32. The adhesive member 260 may wholly penetrate along the thickness direction of the first sheet 30 and the second sheet 40 so that the first penetrating layer part 66 and the second penetrating layer part 67 have contact with each other.

FIG. 9 is a cross-sectional view illustrating a wiring member-equipped adherend 310 according to a third modification example. The wiring member-equipped adherend 310 is different from the wiring member-equipped adherend 10 described above in that a first sheet 330 has a multilayer structure. The first sheet 330 has a double layer structure of the non-woven cloth layer 36 and a fusion layer 39.

The fusion layer 39 is stacked closer to the wire-like transmission member 50 in relation to the non-woven cloth layer 36. The fusion layer 39 and the wire-like transmission member 50 are fused and fixed to each other. The fusion layer 39 is the layer more suitable for fusion to the wire-like transmission member 50 than the non-woven cloth layer 36. Accordingly, fixation strength of the spot fixing part 102 is increased, and the spot fixing part 102 hardly comes out from even a wire-like transmission member 350 having a large thickness, for example. The fusion layer 39 includes a resin material, or preferably includes a thermoplastic resin material. The resin material of the fusion layer 39 is softened and fused to a fusion target. The resin material is not particularly limited, however, the above resin material described for the material of the non-woven cloth layer 36 can be used, for example. It is preferable that a material of the covering layer 52 and a material of the fusion layer 39 have compatibility. Herein, a resin material constituting the covering layer 52 and a resin material constituting the fusion layer 39 are the same type of material. A resin material constituting the fusion layer 39 and a resin material constituting the covering layer 52 are PVC or polyolefin, for example.

The fusion layer 39 is a non-fibrous material sheet. The non-fibrous material sheet is a sheet which does not have a fiber. The fusion layer 39 may be a sheet having an evenly filled cross-sectional surface (also referred to as a non-foam sheet or a solid sheet, for example). The fusion layer 39 may also be a foam sheet, for example.

The fusion layer 39 is partially stacked to the non-woven cloth layer 36. The fusion layer 39 is provided to the cover part 33, and is not provided to the sheet fixing part 34 in the first sheet 330. A surface of the fusion layer 39 constitutes the second surface 32 in the cover part 33. A surface of the non-woven cloth layer 36 constitutes the second surface 32 in the sheet fixing part 34. Accordingly, the void 38 easily appears in the first surface 31 and the second surface 32 of the sheet fixing part 34 also in the first sheet 330 having the multilayer structure of the non-woven cloth layer 36 and the fusion layer 39. Accordingly, the first penetrating layer part 66 and the third penetrating layer part 68 are obtained also in the wiring member-equipped adherend 310. The fusion layer 39 may be partially stacked to the non-woven cloth layer 36. The void 38 may not appear in the second surface 32 in the sheet fixing part 34 of the first sheet 330.

The fusion layer 39 and the non-woven cloth layer 36 are fixed to each other while the surface of the fusion layer 39 and the surface of the non-woven cloth layer 36 have contact with each other. A fixing state of the fusion layer 39 and the non-woven cloth layer 36 is not particularly limited, however, fixing by fusion or adhesion is preferable. The non-woven cloth layer 36 includes the void 38, thus the resin material or the adhesive agent of the fusion layer 39 can enter the void 38 and can be fixed thereto. Such a configuration causes so-called anchor effect, thus the fusion layer 39 and the non-woven cloth layer 36 are rigidly fixed. In the description herein, the fusion layer 39 and the non-woven cloth layer 36 are fused to each other. That is to say, the resin of the fusion layer 39 enters between the fibers 37 of the non-woven cloth layer 36 while having flowability, and is then hardened. Accordingly, a state where the resin of the fusion layer 39 enters between the fibers 37 of the non-woven cloth layer 36 is maintained, and the fusion layer 39 and the non-woven cloth layer 36 are rigidly fixed.

The configurations described in the embodiments and modification examples thereof can be appropriately combined as long as they are not contradictory.

### EXPLANATION OF REFERENCE SIGNS

10, 10X, 110, 210, 310 wiring member-equipped adherend
20 adherend
22 attached surface
30, 330 first sheet
31 first surface
32 second surface
33 cover part
34 sheet fixing part
36 non-woven cloth layer (first non-woven cloth)
37 fiber
38 void
39 fusion layer
40, 140 second sheet
41 third surface
42 fourth surface
43 cover part
44 sheet fixing part
45 extension part
46 non-woven cloth layer (second non-woven cloth)
47 fiber
48 void
50, 350 wire-like transmission member
51 transmission wire body
52 covering layer
60, 60X, 160, 260 adhesive member
60B adhesive member sheet
61 first layer part
62, 262 second layer part
63, 263 connection part
64, 164 exposed part
65 protruding part
66 first penetrating layer part
67 second penetrating layer part
68 third penetrating layer part
80, 81 press member
100 wiring body
102 spot fixing part

1. A wiring member-equipped adherend, comprising:
an adherend including an attached surface;
a first sheet overlapped with the attached surface;
a second sheet overlapped with the first sheet;
a wire-like transmission member located between the first sheet and the second sheet; and
an adhesive member bonding the first sheet, the second sheet, and the adherend, wherein
the adhesive member includes a first layer part provided between the first sheet and the attached surface, a second layer part provided on an opposite side of the first sheet from a side of the attached surface, and a connection part connecting the first layer part and the second layer part on a lateral side of the first sheet.

2. The wiring member-equipped adherend according to claim 1, wherein
the second layer part is located between the first sheet and the second sheet.

3. The wiring member-equipped adherend according to claim 2, wherein
the adhesive member includes an exposed part exposed to a lateral side of a side edge of the second sheet along a width direction of the second sheet.

4. The wiring member-equipped adherend according to claim 3, wherein
a protruding part protruding farther from the attached surface than the second layer part is provided to the exposed part along a thickness direction of the adhesive member.

5. The wiring member-equipped adherend according to claim 1, wherein
the second sheet includes an extension part extending to a lateral side of the first sheet to cover the connection part.

6. The wiring member-equipped adherend according to claim 1, wherein
the adhesive member includes a first end portion and a second end portion along an extension direction of the wire-like transmission member, and
the connection part continuously extends from the first end portion to the second end portion.

7. The wiring member-equipped adherend according to claim 1, wherein
the first sheet includes a first non-woven cloth having contact with the first layer part, and
the adhesive member includes a first penetrating layer part continuously formed with the first layer part and penetrating the first non-woven cloth.

8. The wiring member-equipped adherend according to claim 1, wherein
the second sheet includes a second non-woven cloth having contact with the second layer part, and
with the second layer part and penetrating the second non-woven cloth.

9. The wiring member-equipped adherend according to claim 1, wherein
the wire-like transmission member is fixed to any one of the first sheet and the second sheet.

10. A method of manufacturing a wiring member-equipped adherend, comprising:
overlapping an adhesive member sheet, a first sheet, a wire-like transmission member, and a second sheet in this order on an attached surface of an adherend and bending a part of the adhesive member sheet protruding to a lateral side of the first sheet so that the part is overlapped to have contact with the second sheet; and
heating and softening the adhesive member sheet which has been bended to bond the adherend, the first sheet, and the second sheet via the adhesive member sheet.
